(19) United States
(12) Patent Application Publication
(10) Pub. No.: US 2013/0082831 A1
(43) Pub. Date: Apr. 4, 2013

(54) CHILD SAFETY ALERT DEVICE

(71) Applicant: Rachel Byrne, Saratoga Springs, NY (US)

(72) Inventor: Rachel Byrne, Saratoga Springs, NY (US)

(21) Appl. No.: 13/630,403

(22) Filed: Sep. 28, 2012

Related U.S. Application Data
(60) Provisional application No. 61/541,454, filed on Sep. 30, 2011.

(51) Int. Cl. B60Q 1/00

(52) U.S. Cl. 340/457

(57) ABSTRACT

In one embodiment, the invention includes a method for continuously alerting a user of a presence of a child in a car safety seat, the method including: providing an alert system including a continuous audible prompt, the alert system removeably attached to the car safety seat; placing the child in the car safety seat; removing the alert system from the car safety seat; transferring the alert system to a location visible to the user, such that the user remains continuously alert to the presence of the child in the car safety seat, until the child is removed from the car safety seat.

### CROSS REFERENCE TO RELATED APPLICATIONS

This application claims the benefit of U.S. Provisional Application Ser. No. 61/541,454, filed on Sep. 30, 2011, entitled “Child Safety Alert Device,” which is incorporated herein by reference in its entirety.

### TECHNICAL FIELD

The disclosure relates generally to alert devices, and more particularly, to an alert device for remembering a child in a car safety seat.

### BACKGROUND ART

Children unintentionally being left within vehicles for extended periods of time are a major concern, across the world. Statistics show that this problem occurs in all socio-economic groups, ethnicities, personality types, and ages of caregivers, with no differences between male or female caregivers. A child being left alone in a vehicle is problematic, and even fatal, for any number of reasons.

For example, each year, children die from hyperthermia when left unattended in child safety seats within vehicles. The majority of these children were left accidentally when their caregivers failed to remember that the child was in the car with him or her after exiting the vehicle. Over half of the deaths were of children that were two years of age or under. Studies show that the external temperature only needs to be 80° Fahrenheit (F) for the internal temperature of a vehicle to reach fatal temperatures within one hour.

### SUMMARY OF THE INVENTION

In view of the problems and objects set forth above, the present invention provides an alert device for remembering a child in a car safety seat. In one embodiment, the invention includes a method for alerting a user of a presence of a child in a car safety seat, the method comprising: providing an alert system including a continuous audible prompt, the alert system removeably attached to the car safety seat; placing the child in the car safety seat; removing the alert system from the car safety seat; transferring the alert system to a location visible to the user, such that the user remains continuously alert to the presence of the child in the car safety seat, until the child is removed from the car safety seat.

A first aspect of the invention provides a method for continuously alerting a user of a presence of a child in a car safety seat, the method comprising: providing an alert system including a continuous audible prompt, the alert system removeably attached to the car safety seat; placing the child in the car safety seat; removing the alert system from the car safety seat; and transferring the alert system to a location visible to the user, such that the user remains continuously alert to the presence of the child in the car safety seat, until the child is removed from the car safety seat.

A second aspect of the invention provides an alert system for continuously alerting a user of a presence of a child in a vehicle, the alert system comprising: a portable device configured to be attached to the user or the vehicle; means for securing the portable device to the user or the vehicle; and means for providing a continuous audible alert to alert the user to the presence of the child in the vehicle.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a perspective view of an alert system device according to embodiments of the invention.

FIG. 2 shows a perspective view of an alert system device according to embodiments of the invention.

FIG. 3 shows a perspective view of an alert system device according to embodiments of the invention.

FIG. 4 shows a perspective view of an alert system device according to embodiments of the invention.

FIG. 5 shows a perspective view of an alert system device according to embodiments of the invention.

FIG. 6 shows a perspective view of an alert system device according to embodiments of the invention.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The disclosure relates generally to alert devices, and more particularly, to an alert device for remembering a child in a car safety seat.

Children unintentionally being left within vehicles for extended periods of time are a major concern, across the world. Statistics show that this problem occurs in all socio-economic groups, ethnicities, personality types, and ages of caregivers, with no differences between male or female caregivers. A child being left alone in a vehicle is problematic, and even fatal, for any number of reasons.

For example, each year, children die from hyperthermia when left unattended in child safety seats within vehicles. The majority of these children were left accidentally when their caregivers failed to remember that the child was in the car with him or her after exiting the vehicle. Over half of the deaths were of children that were two years of age or under. Studies show that the external temperature only needs to be 80° Fahrenheit (F) for the internal temperature of a vehicle to reach fatal temperatures within one hour.

In view of the problems and objects set forth above, the present invention provides an alert device for remembering a child in a car safety seat. In one embodiment, the invention includes a method for continuously alerting a user of a presence of a child in a car safety seat, the method comprising: providing an alert system including a continuous audible prompt, the alert system removeably attached to the car safety seat; placing the child in the car safety seat; removing the alert system from the car safety seat; transferring the alert system to a location visible to the user, such that the user remains continuously alert to the presence of the child in the car safety seat, until the child is removed from the car safety seat.

The structure of the alert system device may comprise any portable device configured to be easily accessible to a user and at least one means for attaching the device to a user or object, for example, a strap of varying lengths with a clip for fastening. Illustrative examples of an alert system include a bracelet, a carabiner clip, or a necklace. Regardless of the form of the alert system, the alert system device may be configured to be clipped onto a portion of the vehicle that is visible to the user, such as the steering wheel, or may be configured to be clipped on to any item that will be removed from the car at the end of a trip. Alternatively, the alert system device may be configured to be attached to the user. For example, the alert device may be a bracelet that is attached to the user's wrist, a necklace that goes around the user's neck, or a carabiner that is attached to the user's clothing or personal possession (such as a purse or handbag).

The alert system device also includes at least one audible prompt. The at least one audible prompt may comprise any object capable of making noise, for example, a bell or any cluster of items that make noise when moved. The audible prompts may comprise a non-electrical audible prompt, such as bells, metal dangles, rattles, and/or may comprise an electronic audible prompt such as a computer chip configured to make a beeping sound or any other electronic sound. It is understood that any number of audible prompts may be included within the alert system device. Further, the alert system device may include a visual prompt, such as brightly colored material or beads.

The alert system device may also include an attached pendant that indicates the device is a child safety device. In one embodiment, the pendant may include the words “Child Alert”.

In the embodiment that the alert system device is a bracelet or a necklace, the band of the alert system device may include beading, leather, rubber, cord, metal chain, or any other now known or later developed material suitable for this purpose.

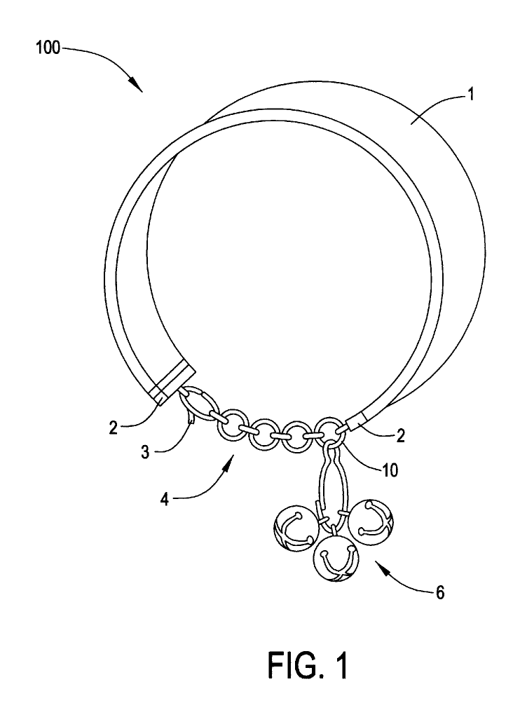

Turning now to FIG. 1, a perspective view of an alert system device 100 according to embodiments of the invention is shown. In this embodiment, the alert system 100 device is a bracelet. The bracelet includes a plain strap 1 with cord ends 2 at each end. The cord ends 2 include metal findings that affix to the strap 1, with a loop that allows the strap 1 to have further attachments. A clasp 3, such as a lobster claw clasp, is attached to one cord end 2. However, clasp 3 may include any clasp known in the art. A length of metal or plastic chain 4 is attached to the other cord end 2 using a jump ring 10 or similar structure. A jump ring 10 is a split ring, which allows the jump ring 10 to be opened and closed with jewelry pliers. The audible prompt in FIG. 1 is shown as a plurality of bells 6. Although only three bells 6 are shown, it is understood that the audible prompt may include any number of bells 6. Alert system device 100 may also include a visual prompt to continuously alert a user of a child in a child safety seat (not shown). For example, strap 1 may include at least one or more highly visible and/or bright colors, and/or highly visible design pattern.

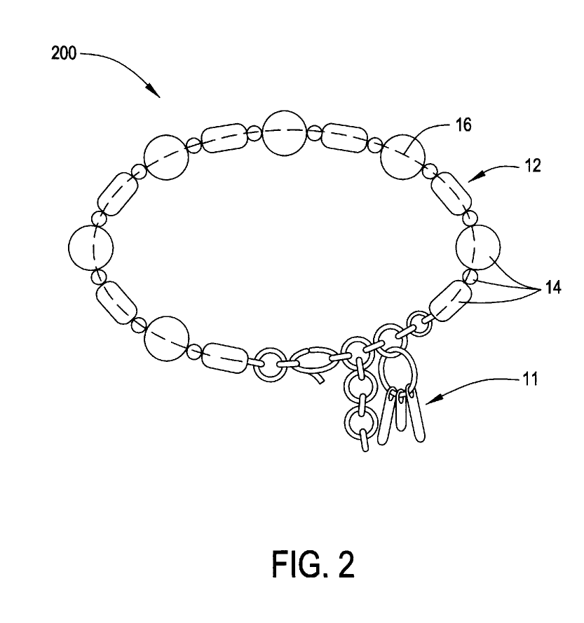

Turning now to FIG. 2, a perspective view of an alert system device 200 according to embodiments of the invention is shown. In this embodiment, the alert system device 200 is a bracelet similar to the device 100 shown in FIG. 1. However, the bracelet in FIG. 2 includes an audible prompt that includes metal dangles 11. Further, the strap 12 of the bracelet includes a plurality of beads 14. Beads 14 may be large, and/or small, and are connected by beading wire 16. It is understood that only large beads may be used or only small beads may be used for beads 14. Beads 14 may be used for decorative purposes only, or can act as a visual prompt to the user as discussed herein.

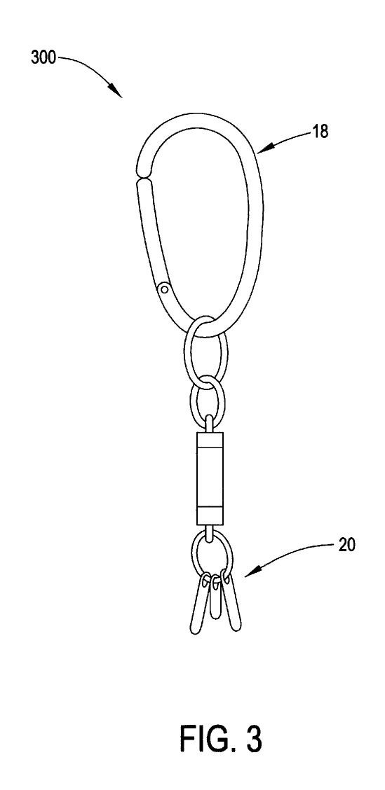

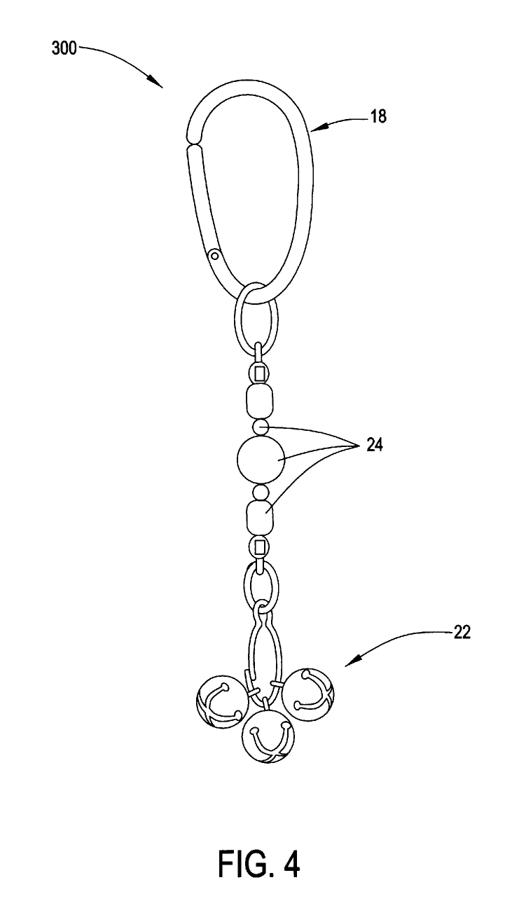

Turning now to FIGS. 3-4, a perspective view of an alert system device 300 according to embodiments of the invention is shown. In these embodiments, the alert system device 300 is a carabiner 18. However, in the embodiment shown in FIG. 3, the audible prompt includes a plurality of metal dangles 20. In the embodiment shown in FIG. 4, the audible prompt includes a plurality of bells 22. In this embodiment, the visual prompt may include a plurality of brightly colored and/or patterned beads 24, a plurality of brightly colored and/or patterned metal dangles 20, or a brightly colored and/or patterned carabiner 18.

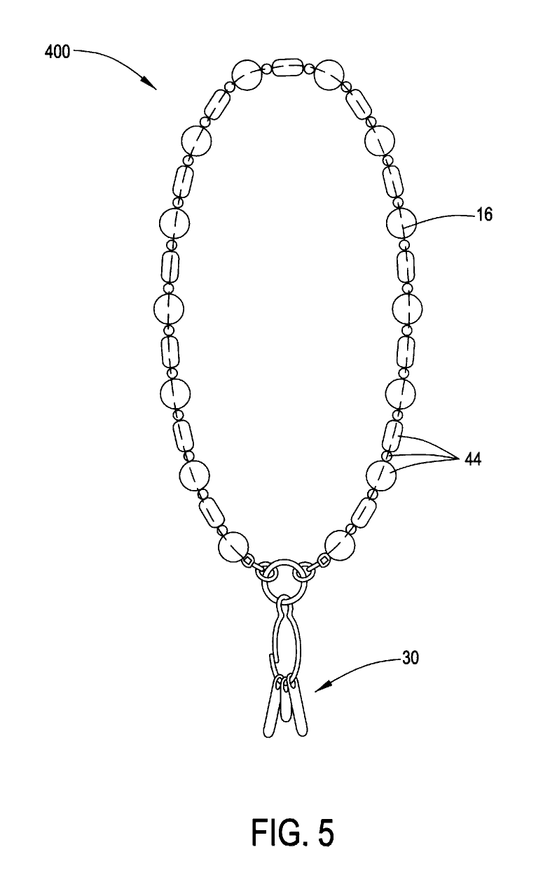

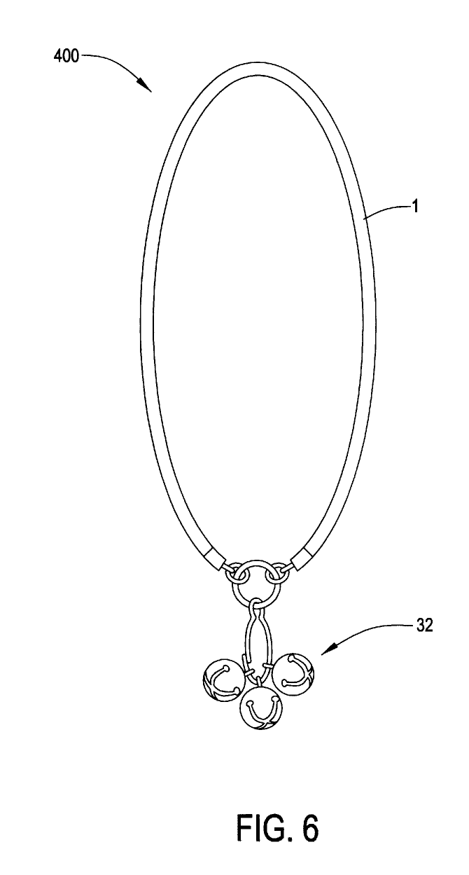

Turning now to FIGS. 5-6, a perspective view of an alert system device 400 according to an embodiment of the invention is shown. In these embodiments, the alert system device 400 is a necklace. This embodiment is similar to the bracelet embodiment of alert system device 100, 200 shown in FIGS. 1-2. However, the length of the strap 1 or beading wire 16 is larger in the necklace embodiment of alert system device 400. In this embodiment, the continuous audible prompt may, similarly, include a plurality of metal dangles 30 (FIG. 5) or a plurality of bells 32 (FIG. 6). Further, the continuous visual prompt may include a plurality of beads 44 (large and/or small) or a brightly colored and/or patterned strap 1.

In operation, each alert system 100, 200, 300, 400 described herein works to alert a user when a child is inadvertently left in a vehicle. One method of use of the alert systems disclosed herein is as follows: A user can keep the alert system on a child's clothing, bag, or car seat, and then when placing the child in the car seat, a user can remove the alert system from the car seat. Then the user can transfer the alert system to a visible location in the car or on the user's person. For example, the user may wear the alert system (i.e., if the alert system is a bracelet or a necklace) or the user may attached the alert system to the vehicle (i.e., if the alert system is a carabiner, the user may attach the alert system to the steering wheel). Further, the user may attach the alert system to an article of clothing. The alert system works to keep the user continuously alert to the presence of the child in the car safety seat, until the child is removed from the car safety seat. Specifically, the audible prompt acts to continuously remind the user that the child is still in the vehicle. For example, if a user inadvertently leaves the vehicle without the child, the audible prompt acts to remind the user to take the child out of the car seat. Further, the visual prompt acts to continuously remind the user that the child is still in the vehicle.

While embodiments of the invention described herein are discussed in connection for use in a vehicle, it is understood that the alert system described herein can be used in connection with any type of vehicle, dwelling, etc. where a child could be left inadvertently.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for continuously alerting a user of a presence of a child in a car safety seat, the method comprising:
providing an alert system including a continuous audible prompt, the alert system removeably attached to the car safety seat;
placing the child in the car safety seat;
removing the alert system from the car safety seat; and
transferring the alert system to a location visible to the user, such that the user remains continuously alert to the presence of the child in the car safety seat, until the child is removed from the car safety seat.

2. The method of claim 1, wherein the continuous audible prompt includes a plurality of bells.

3. The method of claim 1, wherein the continuous audible prompt includes a plurality of metal dangles.

4. The method of claim 1, wherein the alert system further includes a continuous visual prompt.

5. The method of claim 1, wherein the alert system includes a bracelet.

6. The method of claim 1, wherein the alert system includes a necklace.

7. The method of claim 1, wherein the alert system includes a carabiner.

8. An alert system for continuously alerting a user of a presence of a child in a vehicle, the alert system comprising:
a portable device configured to be attached to the user or the vehicle;
means for securing the portable device to the user or the vehicle; and
means for providing a continuous audible alert to alert the user to the presence of the child in the vehicle.

9. The alert system of claim 8, wherein the portable device includes a bracelet.

10. The alert system of claim 8, wherein the portable device includes a necklace.

11. The alert system of claim 8, wherein the portable device includes a carabiner.

12. The alert system of claim 8, further comprising a plurality of bells for providing the continuous audible alert.

13. The alert system of claim 8, further comprising a plurality of metal dangles for providing the continuous audible alert.

14. The alert system of claim 8, further comprising a means for providing a continuous visual prompt.
